(19) United States
(12) Patent Application Publication
(10) Pub. No.: US 2018/0332475 A1
(43) Pub. Date: Nov. 15, 2018

(54) METHOD AND NETWORK NODE FOR TRAFFIC DEPENDENT CELL SHAPING

(71) Applicant: Telefonaktiebolaget LM Ericsson (publ), Stockholm (SE)

(72) Inventors: Andreas NILSSON, Göteborg (SE); Niklas JALDÉN, Enköping (SE); Panagiota LIOLIOU, Sundbyberg (SE); Sven PETERSSON, Sävedalen (SE)

(21) Appl. No.: 15/774,092

(22) PCT Filed: Nov. 24, 2015
(86) PCT No.: PCT/EP2015/077415

§ 371 Date: May 7, 2018

(51) Int. Cl. H04W 16/04; H04W 16/08; H04W 16/30; H04L 12/851; H04W 28/08

(52) U.S. Cl. CPC H04W 16/04; H04W 16/08; H04W 28/085; H04L 47/2441; H04W 16/30

(57) ABSTRACT

A method is provided which may be performed in a network node for traffic dependent cell shaping. The method includes: establishing at least one parameter indicative for a traffic distribution in a cell; selecting, based on the at least one parameter, a traffic situation type among at least a first and a second traffic situation types, wherein each traffic situation type has a respective process running a cell shaping algorithm, and applying, in the cell, the process corresponding to the selected traffic situation type. A corresponding network node, computer program and computer program products are also provided.

### TECHNICAL FIELD

The technology disclosed herein relates generally to the field of reconfigurable antenna systems and in particular to a method and a network node for traffic dependent cell shaping, and related computer programs and computer program products.

### BACKGROUND

A difficulty when deploying wireless communication systems is to properly dimension the system in accordance with need. One difficulty in this regards is that the capacity needed in the system varies over time. An operator therefore needs to dimension the system such as to be able to handle the busy hours when the traffic demand is the highest. In an office environment, there may be a need for high capacity during office hours, whereas the need may be much lower during night when only a fraction of the employees, if any, are present in the buildings. Similarly, during commute hours the capacity need may be high at a subway station, just as it may be high in a residential area in the evening when subscribers are consuming streaming services in their homes. It is common for operators of communications systems to try to guarantee some level of service for a given percentage of users per area, which in view of this varying capacity need makes the proper dimensioning even more difficult.

Advanced antenna systems are becoming more common in order to exploit the spatial characteristics of the propagation channel and thereby increase the system capacity. A reconfigurable antenna system (RAS) entails the possibility to adapt antenna beam patterns and is considered to be a key enabler for dynamically changing the cell sizes and/or shapes, known as cell shaping. The antenna tilt is one antenna parameter that can be reconfigured and it is typically applied through remote electrical tilt (RET). Technological advancements will however most likely introduce more possibilities to modify the antenna lobe shapes, far beyond the one-dimensional tilt. This opens up for new possibilities to improve network performance.

With beamforming, the radiation pattern may be controlled by transmitting a signal from a plurality of antenna elements with an element specific gain and phase. In this way, radiation patterns with different pointing directions and beam widths in both elevation and azimuth directions may be created. With so called user equipment (UE)-specific beamforming even narrower beams may be formed to specific UEs in order to increase received signal power while at the same time controlling interference generated towards other UEs that, for instance, are receiving data transmissions.

Besides the above gains from adjusting the beam shapes used for transmissions giving increased received power (increased Signal-to-noise ratio, SNR) as well as a possibly lower interference (increased signal-to-interference-plus-noise ratio, SINR) in a multi cell scenario, a further gain is the possibility to dynamically share the load between cells; if one cell becomes overloaded, the overall capacity in the network decreases due to the system not being able to support the users per area with the minimum requested service. If using beam-forming, the cell size and/or shape may be adapted and load thereby be shared between cells.

A number of automatic cell shaping methods has been proposed, typically referred to as RAS-SON (Re-configurable Antenna System - Self-Organizing Network) methods. Most of these methods are blind or semi-blind in the sense that they deduce a set of candidate cell shapes and try these in the network for a given period of time and then evaluate which solution performed best. The intuition behind this method is that by choosing the best setting iteratively, the network performance gradually increases.

In order to make a good choice regarding the best setting, all evaluations need to be statistically representative of the network characteristics. This means that the amount of time needed for evaluating each setting, in order to deem it as good or bad, has to be long enough to capture an average of the traffic situation. As noted earlier, the traffic over a day may be very dynamic, which directly affects the smallest time needed for measurements per evaluation. One problem with this is that such solutions inherently become slow, and hence not capable of tracking rapid traffic movement/changes. Thus, to a large extent the optimized antenna settings obtained via classical RAS-SON methods result in one solution that fits the average traffic distribution.

### SUMMARY

An objective of the present disclosure is to solve or at least alleviate at least one of the above mentioned problems.

The objective is according to an aspect achieved by a method performed in a network node for traffic dependent cell shaping. The method comprises establishing at least one parameter indicative for a traffic distribution in a cell; selecting, based on the at least one parameter, a traffic situation type among at least a first and a second traffic situation types, wherein each traffic situation type has a respective process running a cell shaping algorithm; and applying, in the cell, the process corresponding to the selected traffic situation type.

The method provides several advantages. In contrast to prior art wherein the trial-and-error approach of the blind optimization methods with the necessary evaluation time makes fast tracking of traffic changes impossible, the present method indeed facilitates such fast tracking. The method facilitates to dynamically exploiting the adaptive nature of active antenna systems. In contrast to prior art, resulting in use of antenna settings that are good in average, but at the same time sub-optimal during the whole day, the antenna settings may, according to the present method, be adapted to particular traffic situations.

The predictable nature of the traffic distribution, both spatially and temporally, in a network is utilized, and optimized antenna settings are used for each of a number of traffic situation types corresponding to these traffic distributions. This results in an increased performance of the network by the network being capable of adapting to the changing demand from the end users. By measuring and analyzing the traffic variations in the network it is possible to identify a number of different traffic situations.

The objective is according to an aspect achieved by a computer program for a network node for traffic dependent cell shaping. The computer program comprises computer program code, which, when executed on at least one processor on network node causes the network node to perform the method as above.

The objective is according to an aspect achieved by a computer program product comprising a computer program as above and a computer readable means on which the computer program is stored.

The objective is according to an aspect achieved by a network node for traffic dependent cell shaping. The network node is configured to: establish at least one parameter indicative for a traffic distribution in a cell; select, based on the at least one parameter, a traffic situation type among at least a first and a second traffic situation types, wherein each traffic situation type has a respective process running a cell shaping algorithm; and apply, in the cell, the process corresponding to the selected traffic situation type.

Further features and advantages of the embodiments of the present teachings will become clear upon reading the following description and the accompanying drawings.

### BRIEF DESCRIPTION OF THE DRAWINGS

FIG. 1 illustrates graphs over measured traffic variation over time in a real network.

FIG. 2 illustrate different traffic scenarios and corresponding measured traffic variation.

FIG. 3 illustrates a flow chart over steps of an embodiment of a method in accordance with the present teachings.

FIG. 4 illustrates an environment in which embodiments of the present teachings may be implemented.

FIG. 5 illustrates graphs on total traffic load and number of handovers during a day.

FIG. 6 illustrates exemplary traffic situations according to the present teachings.

FIG. 7 illustrates a flow chart over steps of an embodiment of a method in accordance with the present teachings.

FIG. 8 illustrates schematically a network node and means for implementing embodiments of the present teachings.

FIG. 9 illustrates a network node comprising function modules/software modules for implementing embodiments of the present teachings.

### DETAILED DESCRIPTION

In the following description, for purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail. Same reference numerals refer to same or similar elements throughout the description.

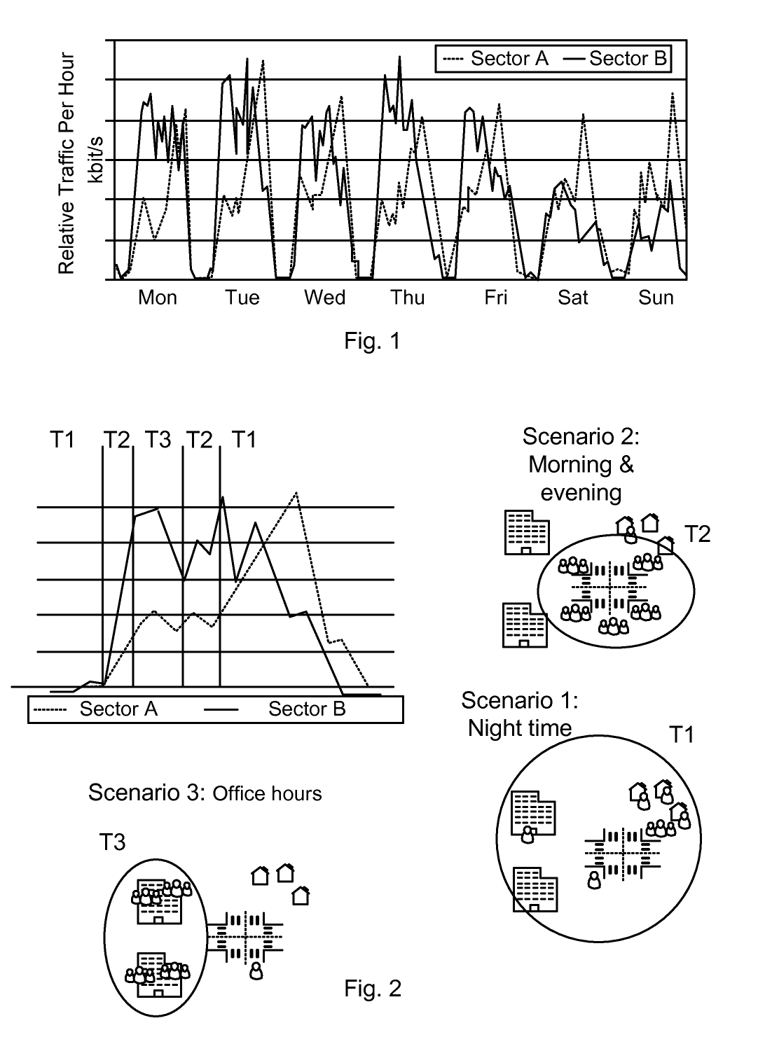

FIG. 1 illustrates graphs over measured traffic variation over time in a real network. The graphs in FIG. 1 represent measured traffic in the real system for two different sectors, wherein the graph drawn with dashed line represents a first sector (Sector A) and the graph drawn with solid line represents a second sector (Sector B). As can be noted, the traffic is neither random nor chaotic, but rather dynamic and still predictable. Relative traffic per hour (y-axis) in kilobits per second (kbits/s) is shown as function of time (x-axis). The traffic patterns during business days, i.e. Monday, Tuesday, Wednesday, Thursday and Friday are quite similar to each other, as are the traffic patterns during weekend, i.e. Saturday and Sunday. Likewise, the traffic patterns in the different sectors are also similar to each other. The traffic changes are hence, to a large extent, predictable.

FIG. 2 illustrates different traffic scenarios and corresponding measured traffic variations. The different traffic scenarios are shown overlaid on the measured traffic variation over a day. For example, there may be high traffic in one area during the day, and lower at night. This can be exemplified by scenario 3 wherein there is high traffic in the office building area during office hours, and then in scenarios 1 and 2 (night time and morning/evening, respectively) there is no or very little traffic in this office building area. As another example, the residential area may have higher traffic at night (scenario 1), while lower during the day (scenario 3). Since the traffic distribution changes, there is not only one setting that is optimal for all of a set of different scenarios.

This predictability is taken advantage of in the present teachings. In an aspect, information relating to the traffic distribution is obtained, e.g. measured and/or calculated. The traffic distribution is also characterized into discrete scenarios. Given each scenario one optimized antenna setting is applied. The traffic is measured and its predictable nature and distribution is utilized to form a number of antenna settings that suits each traffic scenario.

By measuring and analyzing the traffic variations in the network it is possible to identify a number of different traffic situation types. In reality, every moment in time will have different traffic distributions. However in order to limit the number of different traffic situation types, traffic distributions that are similar to each other, e.g. with respect to some Key Performance Indicators (KPIs), may be grouped into one and same traffic situation type.

Some metrics that can be established, e.g. by measuring, and used for establishing the traffic distributions are for example, base station utilization, utilization for a cluster of base stations, offered traffic per cell, UE positions, total traffic load in the network, user bitrate, handover rates, which may indicate where UEs are going etc. The UE positions may for instance be based on Global Positioning System (GPS) or coarse directional information through precoder matrix indicator (PMI) reports, Timing advance (TA), angle-of-arrival (AoA) measurements, etc. Such directional information may be used in order to get some indication of where the UEs are located, or at least knowledge about which the most favorable directions are.

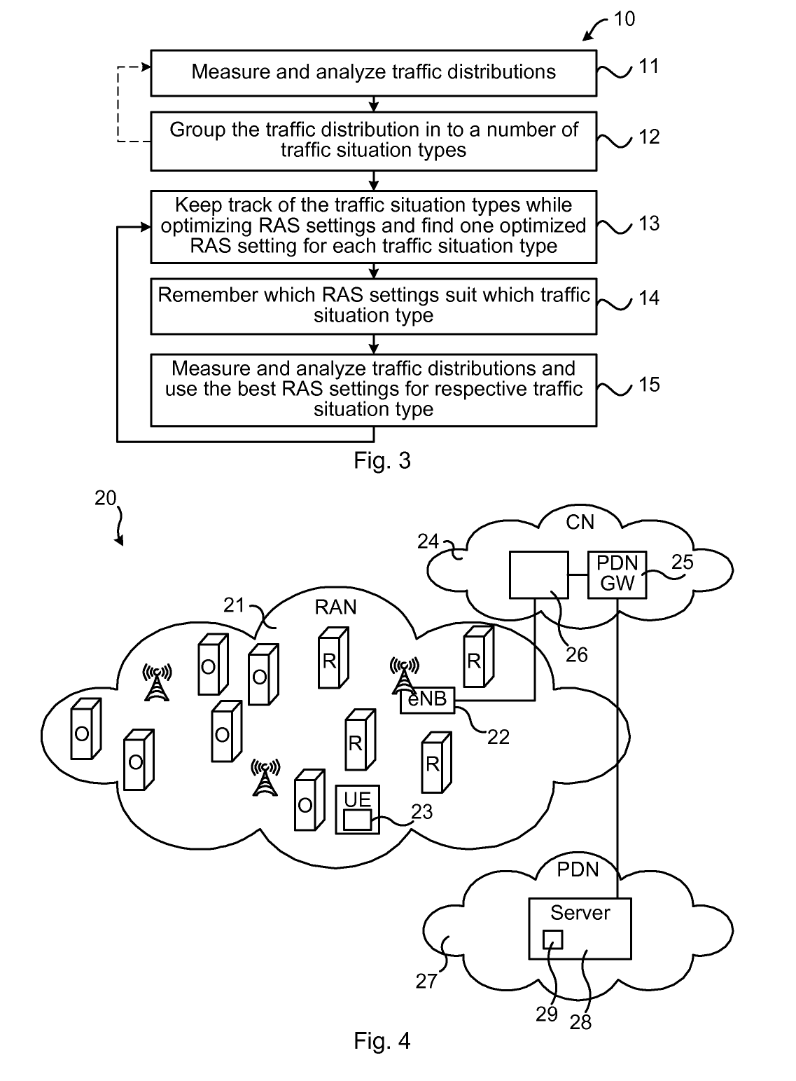

FIG. 3 illustrates a flow chart over steps of an embodiment of a method in accordance with the present teachings. In various embodiments, a method 10 according to the teachings may comprise the following steps:

In box 11, the traffic distribution is measured. Measurements are collected and analyzed. Such analysis can be made according to prior art. One example on measured traffic distribution and collected measurements was described earlier and illustrated with reference to FIG. 1, giving the relative traffic per hour in different sectors.

In box 12, the nature of the traffic distribution is characterized and divided into a number of traffic situations. As a few particular examples, the traffic situations may comprise a high traffic load situation, a low traffic load situation, a certain traffic location situation, e.g. a location at which the majority of traffic is generated, etc. The measurements are used to group the traffic distributions into a finite number of traffic situation types. This grouping may be done such that similar (w.r.t. some KPI) traffic distributions are grouped into the same traffic situation type. For the grouping, similar KPIs may be used as they may later also be used to identify which traffic situation type exists in the network.

It is noted that the nature of the traffic distribution may vary over time, e.g. over a year or a few years. Boxes 11 and 12 may therefore be repeated, which is indicated by the dashed arrow from box 12 to 11. This is to ensure that the traffic situation types are still up to date, and if not, then they should be updated.

In box 13, antenna settings (for instance RAS settings, which are used as example in FIG. 3 and in the following) are determined for each traffic situation type defined in box 12. This may be done in a way similar to existing network planning. The RAS settings may be optimized individually for each traffic situation type. This means that appropriate RAS settings can be found and adapted independently for each traffic situation type.

In box 14, the current traffic situation is identified during network operation based on several different possible metrics. The RAS settings that are best for each respective traffic situation type may be stored and these RAS settings may then be used later for each respective identified traffic situation type.

In box 15, for each identified traffic situation, pre-optimized RAS settings may be applied. The traffic distributions are continuously monitored (as indicated by the arrow back to box 13) based on specified metrics in order to find out which traffic situation type dominates. That is, depending on how the traffic situation types are defined different traffic situation types might occur simultaneously, but the traffic situation type best fitting (dominating) the specified metrics is identified as the currently prevailing traffic situation type. Some examples of possible such specified metrics were mentioned earlier (e.g. base station utilization, offered traffic per cell or sector etc.). In the identification of traffic situation type thresholds for various KPIs may be used. When identifying the current traffic situation type, the closeness of the established KPIs to the respective thresholds may be weighed and used to determine which traffic situation type is the most dominating. The pre-determined RAS settings corresponding to the identified traffic situation type are applied.

The number of different traffic situation types should preferably not be too high as the system would then have to change RAS settings often and each change of the RAS settings may temporarily degrade the system performance. Furthermore, with too many different traffic situation types it may be more difficult to distinguish between them, which in turn may increase the risk of using a non-optimal setting. Another reason for keeping down the number of different traffic scenario types may be that since the RAS settings are optimized individually for each traffic situation type, more traffic situations will result in a longer optimization time. However, since these RAS settings may be done offline, such prolonged optimization time may be acceptable.

The optimization of the RAS settings for each traffic situation type may be done prior to the network installation by classical methods of network planning. One difficulty that might then arise is that the traffic movements and variations can be hard to predict. Another method is to use different SON algorithms as mentioned earlier. It is also possible to combine both, wherein a skilled network planner deduces the initial network settings, and a SON algorithm may be used to fine-tune these settings while the system is up and running. Yet another example on how SON algorithms may be used according to the present teachings is to build a model of the network and the traffic distributions in software and simulate the performance for different RAS settings. This method is more complex, but has the potential to be much quicker, and decouples the risk of evaluating poor settings in the real network. Either of these SON algorithms could be applied together with the present teachings as long as the system keeps track of the traffic situation types during the RAS optimizations. Since one RAS optimization has to be done for each traffic situation type, the total time for the RAS optimizations may increase for the present teachings compared to using one single RAS setting for all traffic distributions. However, once the optimized RAS settings are found for each traffic situation type, the performance of the system may be significantly improved compared to using one static RAS setting all the time.

FIG. 4 illustrates an environment in which embodiments of the present teachings may be implemented. In particular, a communications system 20 is illustrated comprising a radio access network (RAN) 21 and a core network (CN) 24. An external packet data network (PDN) 27 is also illustrated.

The RAN 21 comprises radio access nodes 22, which may be denoted differently, e.g. base station, evolved NodeB, or eNB to mention a few examples. The radio access node 22 provides wireless communication for communication devices 23 residing within its coverage area. In this context it is noted that one such radio access node 22 may control several geographical areas, e.g. cells or sectors.

The CN 24 comprises various network nodes, which may also be denoted differently depending on communication system at hand. In LTE, for instance, the CN 24 may comprise entities such as a Mobility Management Entity (MME) and packet data network gateways (PDN GW) providing connectivity to e.g. the PDN 27.

The communication system 20 may comprise or be connectable to a PDN 27, which in turn may comprise a server 28 or cluster of servers, e.g. a server of the Internet (“web-server”) or any application server. Such server 28 may run applications 29. It is noted that some embodiments of the present teachings may be implemented in a distributed manner, locally and/or in a centralized component (e.g. in a so called cloud environment).

FIG. 4 also illustrates a city with some office buildings (indicated by letter “O”) and some residential buildings (indicated by letter “R”).

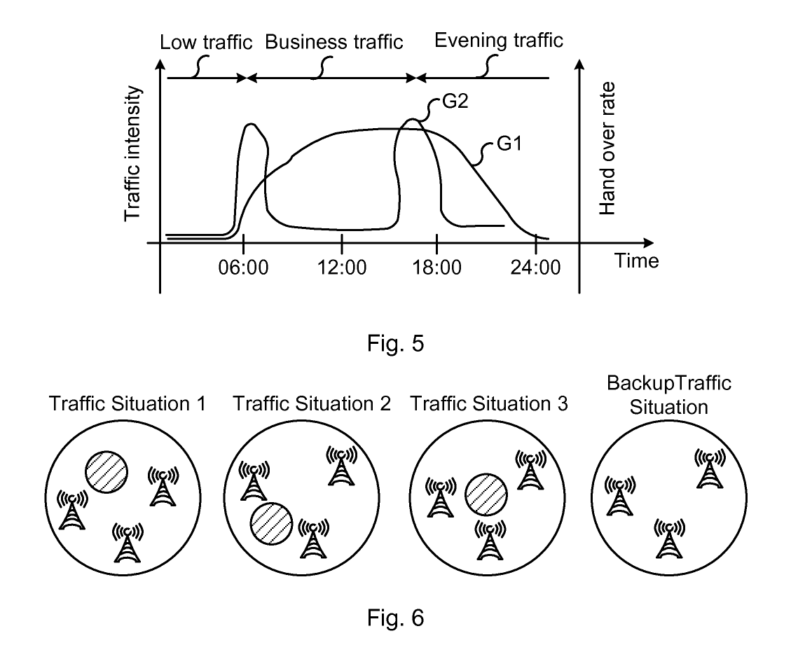

FIG. 5 illustrates graphs on total traffic load and number of handovers during a day. The total traffic load and handover rate (y-axes), respectively, are shown as function of time (x-axis). The total traffic load (indicated as traffic intensity in the figure) as function of time is illustrated by the graph indicated at G1. The total number of handovers varies during a day, as is illustrated by the graph indicated at G2. By analyzing the data in FIG. 5, three different traffic situations have been identified: Low Traffic, Business Traffic and Evening Traffic. During Business Traffic most of the traffic is in the office buildings and during Evening Traffic most of the traffic is in the residential buildings. RAS settings are optimized individually for each traffic situation type. For example, during Low Traffic, the beams transmitted from the base stations could be more up-tilted to increase the path gain of the UEs. During Business Traffic most of the base stations may focus their energy towards the office buildings and during Evening Traffic most base stations may focus their energy towards the residential buildings. Once the optimized RAS settings (final RAS settings) have been found for each traffic situation type, the system continuously measures the traffic load and handover statistics, evaluate which traffic situation type is the dominating one and then applies the corresponding RAS settings.

One efficient way to define different traffic situation types is to measure the positions of the UEs by exploiting some network information. The UE positions may, as mentioned earlier, be found for example by GPS signaling, TA measurements, PMI statistics, triangulation etc. In this way it is possible to localize different hotspots scenarios that typically occur in networks in a periodical manner. For example, during lunch time many people typically gather in lunch restaurants and during weekends people gather in shopping malls. The different hotspot scenarios can then easily be divided into different traffic situation types.

FIG. 6 illustrates exemplary traffic situations according to the present teachings. A backup traffic situation may also be defined that may be used for all identified traffic distributions that do not match any of the already defined traffic situations. This backup traffic situation may then be used whenever a non-categorized traffic distribution occurs. FIG. 6 illustrates three different traffic situation types, denoted Traffic Situation 1, Traffic Situation 2 and Traffic Situation 3, corresponding to three different hotspot scenarios. The hotspots are illustrated as circles with lines. At the rightmost part of FIG. 6 a Backup Traffic Situation is shown that does not apply to any specific traffic distribution, but may be used if the current traffic distribution does not apply to any of the first three Traffic Situations. Some thresholds of different traffic measurement metrics may be defined for each of the first three traffic situation types so as the system can decide which traffic situation type (Traffic Situation 1, Traffic Situation 2 or Traffic Situation 3) the current traffic distribution belongs to. As an example, one threshold for Traffic Situation 1 could be that more than 60% of the total traffic is located within the hotspot area. If not all the thresholds for any of the first three traffic distributions are fulfilled, the Backup Traffic Situation may be used. When optimizing the RAS settings for the Backup Traffic Situation type, all traffic distributions except the one corresponding to the first three Traffic Situations could be used to gather measurements. That is, the Backup Traffic Situation type is an average of all traffic distributions falling outside the defined traffic situation types.

Today, RAS-SON algorithms are typically very time consuming and it can take several weeks to tune a network in a city. Operators typically run one RAS-SON algorithm for a city to tune the network and after a couple of weeks, when the antenna settings are tuned, the RAS-SON algorithm stops and the resulting antenna settings are used henceforth.

In contrast to this, the present teachings defines a number of traffic situations, e.g. as a first step. Then one separate process of a cell-shaping algorithm (e.g. RAS-SON algorithm) is set up for each traffic situation. This means that several individual processes (e.g. of one or more RAS-SON algorithms) are running in parallel and switched between. That is, only the process of the cell-shaping algorithm corresponding to the present traffic situation is actually on, while the other ones are on hold. When the traffic situation changes it is important that the system remembers which RAS settings that have been evaluated before (and how good they were) so that when the same traffic situation reoccurs the process does not have to start over from the beginning. In this context, it is noted that the term algorithm may be interpreted as a sequence of instructions to be executed in order to improve RAS settings (or other relevant settings).

In contrast to known methods using different antenna settings for recurring time periods, the present teachings instead defines different traffic situation types. The traffic situation types are not dependent on time of day as such, but adapted to the actual traffic situation at hand. While the known method would apply certain antenna settings e.g. between 9 am and 17 pm every day, the method according to the present teachings would account for e.g. weekends or holidays having differing traffic situations during those times of day. For instance, the present method would recognize that the traffic situation in a cell on a Monday between office hours might differ from the traffic situation in the cell on a Sunday. According to the present teachings, the traffic distribution is continuously monitored and mapped to the different traffic situations. This gives a more flexible solution than known methods, as described, i.e. it might happen that the traffic distribution differs compared to how it usually looks and then the predefined time periods will give the wrong RAS settings.

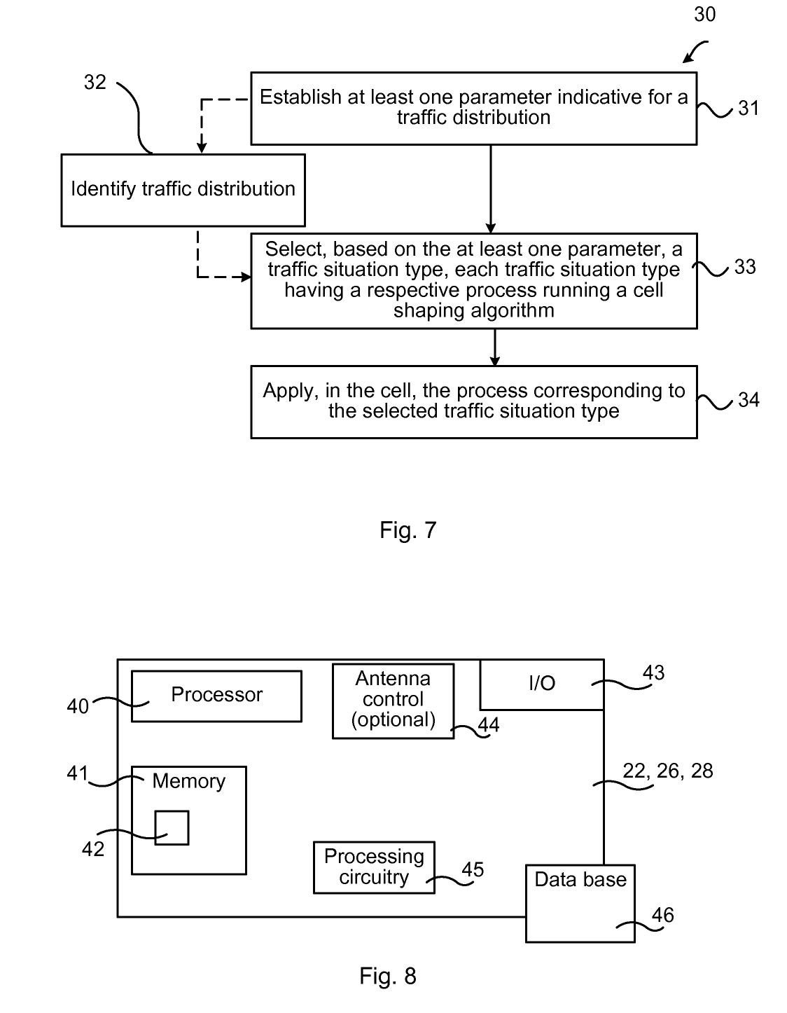

The various features and embodiments that have been described may be combined in many different ways, examples of which are given in the following, with reference first to FIG. 7.

FIG. 7 illustrates a flow chart over steps of an embodiment of a method in accordance with the present teachings. The method 30 may be performed in a network node 22, 26, 28, e.g. an access point, for traffic dependent cell shaping. The method 30 comprises establishing 31 at least one parameter indicative for a traffic distribution in a cell. The establishing 31 may comprise measuring some parameter e.g. utilization of a cluster of radio access nodes 22, or calculating the parameter or receiving or inquiring the parameter from another node or from a database.

The method 30 comprises selecting 33, based on the at least one parameter, a traffic situation type among at least a first and a second traffic situation types, wherein each traffic situation type has a respective process running a cell shaping algorithm.

The method 30 comprises applying 34, in the cell, the process corresponding to the selected traffic situation type.

The method 30 provides several advantages. For instance, by creating different traffic situation types e.g. in view of traffic distribution, optimized settings for different processes of a cell shaping algorithm can be provided. The processes are not dependent on or bound to certain pre-defined times of day, but are instead based on and triggered by the actual traffic situation at hand, i.e. irrespective of time of day.

Further, the provided method 30 facilitates dynamically exploiting the adaptive nature of adaptive antenna systems (AASs) to track traffic changes. This may result in a decreased number of sites needed for a well operating radio access network (RAN), which in turn decreases the hardware costs, as well as the maintenance cost, and cost of operation, e.g. owing to decreased energy consumption.

An algorithm, such as a cell-shaping algorithm (e.g. a RAS-SON algorithm), may be defined as a set of step-by-step operations to be performed. The cell-shaping algorithm uses parameters to make a change in the network, with the aim to find the parameters that are optimized in some sense, e.g. in view of coverage or throughput. A process, in this context, can be defined as an instance of a program run in e.g. a computer, and in particular a process running the cell-shaping algorithm.

According to the present teachings, the cell-shaping algorithm aims at finding the parameters giving e.g. the best possible antenna settings, transmission power, etc. by running a respective process of the cell-shaping algorithm for each respective traffic situation type. That is, multiple such processes of the cell-shaping algorithm are run: one process for each traffic situation type. Each such process then has its own parameters to improve. The parameters may comprise any parameter having impact on e.g. coverage, throughput, capacity etc.

It is noted that the method 30 may be performed in a system as well. In particular, the different steps may be performed in a distributed manner, wherein devices are configured to collaborate. For instance, one or more steps may be performed by a first device (e.g. the network node 22, 26, 28) and other steps by other devices (e.g. in a core network node 26). As a particular example, an implementation that may be envisioned is that the establishing 31 the at least one parameter and the selecting 33 a traffic situation type based on the at least one parameter may be performed by a core network node 26 or PDN server 28, and that the network node 22 receives information on this and applies different processes corresponding to the selected traffic situation type.

In an embodiment, the method 30 comprises identifying 32, based on the establishing 31, the traffic distribution in the cell as one of at least a first and a second traffic situation types or as a traffic situation type different than the at least first and second traffic situation types.

In a variation of the above embodiment, the method 30 comprises, for the case that the traffic distribution in the cell is identified as a traffic situation type different than the at least first and second traffic situation types, classifying the traffic distribution in the cell as a third traffic situation type. A traffic situation type that does not fit into any already existing traffic situation type, may thus be the basis for creating a new traffic situation type. The method 30 is thus flexible and different degrees of accuracy may be provided e.g. in that the method meets the different needs of different traffic situations by using different sets of parameters which are to be adapted to the particular traffic situation type. There may be a tradeoff between the number of different traffic situation types and efficiency in that it may be inefficient use of e.g. processing capacity to alter between too many different traffic situations.

In various embodiments the method 30 comprises grouping traffic distributions into one of the at least first and second traffic situation types based on the traffic distributions having one or more identical key performance indicators, KPIs, or differing less than a set value.

In various embodiments the method 30 comprises applying as initial values, in the respective process running the cell shaping algorithm, current process parameter values of the selected traffic situation type.

In a variation of the above embodiment, the method 30 comprises updating the process parameters of the process corresponding to the selected traffic situation type.

In some embodiments, the algorithm for improving the antenna settings comprises a re-configuration antenna system self-organizing network, RAS-SON, algorithm.

In various embodiments, the at least one parameter indicative for the traffic distribution comprises one or more of: utilization of a radio access node 22, utilization of a cluster of radio access nodes 22, offered traffic in the cell, positions of communication devices 23, total traffic load in a network 20, user bitrate and handover rate of communication devices 23. It is noted that a user bitrate, throughput, traffic load, handover rate etc. may be per cell or sector, per cluster of cells or sectors, per site or in the whole network.

In various embodiments, the process parameter of the processes running the cell shaping algorithm comprise one or more of: antenna settings of a re-configurable antenna system, transmission power, number of sectors, number of communication device specific beamforming ports.

In various embodiments, the method 30 comprises, for each process for which all process parameters have converged to their final values, applying these final values for the cell-shaping algorithm for the respective traffic situation type. The various embodiments according to the present teachings obtain these final, optimized values faster than conventionally used methods.

FIG. 8 illustrates schematically a network node and means for implementing embodiments of the present teachings.

The network node 22, 26, 28 comprises a processor 40 comprising any combination of one or more of a central processing unit (CPU), multiprocessor, microcontroller, digital signal processor (DSP), application specific integrated circuit etc. capable of executing software instructions stored in a memory 41, which can thus be a computer program product 41. The processor 40 can be configured to execute any of the various embodiments of the method 30 for instance as described in relation to FIG. 7.

The memory 41 can be any combination of read and write memory (RAM) and read only memory (ROM), Flash memory, magnetic tape, Compact Disc (CD)-ROM, digital versatile disc (DVD), Blu-ray disc etc. The memory 41 also comprises persistent storage, which, for example, can be any single one or combination of magnetic memory, optical memory, solid state memory or even remotely mounted memory. A data memory (not explicitly illustrated) may also be provided for reading and/or storing data during execution of software instructions in the processor 40.

The network node 22, 26, 28 may also comprise an input/output device 43, indicated by I/O in FIG. 8. The input/output device 43 may comprise an interface for communication exchange for instance with other network nodes, or other entities of the communications system 20. The input/output device 43 may for instance comprise a communication protocol enabling communication between different nodes.

The network node 22, 26, 28 may also comprise or control an antenna system and may then comprise an antenna control device 44, e.g. used for beamforming etc.

The network node 22, 26, 28 may also comprise or have access to a database 46 for storing e.g. parameter settings, historical data etc.

The network node 22, 26, 28 may also comprise additional processing circuitry 45, e.g. receiving circuitry, transmitting circuitry, etc.

The network node 22, 26, 28 is configured to perform any of the embodiments of the method 30 that has been described herein, e.g. with reference to FIG. 7.

A network node 22, 26, 28 is provided for traffic dependent cell shaping. The network node 22, 26, 28 is configured to:
establish at least one parameter indicative for a traffic distribution in a cell,
select, based on the at least one parameter, a traffic situation type among at least a first and a second traffic situation types, wherein each traffic situation type has a respective process running a cell shaping algorithm, and
apply, in the cell, the process corresponding to the selected traffic situation type.

The network node 22, 26, 28 may be configured to perform the steps of the described embodiments e.g. by comprising a processor 40 and memory 41, the memory 41 containing instructions executable by the processor 40, whereby the network node 22, 26, 28 is operative to perform the steps.

In an embodiment, the network node 22, 26, 28 is configured to identify, based on the establishing, the traffic distribution in the cell as one of at least a first and a second traffic situation types or as a traffic situation type different than the at least first and second traffic situation types.

In an embodiment, the network node 22, 26, 28 is configured to, for the case that the traffic distribution in the cell is identified as a traffic situation type different than the at least first and second traffic situation types, classify the traffic distribution in the cell as a third traffic situation type.

In an embodiment, the network node 22, 26, 28 is configured to group traffic distributions into one of the at least first and second traffic situation types based on the traffic distributions having one or more identical key performance indicators, KPIs, or differing less than a set value.

In an embodiment, the network node 22, 26, 28 is configured to apply as initial values, in the respective process running the cell shaping algorithm, current process parameter values of the selected traffic situation type.

In an embodiment, the network node 22, 26, 28 is configured to update the process parameters of the process corresponding to the selected traffic situation type.

In various embodiments, the algorithm for improving the antenna settings comprises a re-configuration antenna system self-organizing network, RAS-SON, algorithm.

In various embodiments, the at least one parameter indicative for the traffic distribution comprises one or more of: utilization of a radio access node 22, utilization of a cluster of radio access nodes 22, offered traffic in the cell, positions of communication devices 23, total traffic load in a network 20, user bitrate and handover rate of communication devices 23.

In various embodiments, the process parameter of the processes running the cell shaping algorithm comprises one or more of: antenna settings of a re-configurable antenna system, transmission power, number of sectors, number of communication device specific beamforming ports.

In an embodiment, the network node 22, 26, 28 is configured to, for each process for which all process parameters have converged to their final values, apply these final values for the cell-shaping algorithm for the respective traffic situation type.

The present teachings also provide a computer program 42 for a network node 22, 26, 28 for traffic dependent cell shaping. The computer program 42 comprises computer program code, which, when executed on at least one processor on the network node 22, 26, 28 causes the network node 22, 26, 28 to perform the method 30 as has been described.

A computer program product 41 comprising a computer program 42 as described above and a computer readable means on which the computer program 42 is stored is also provided.

The computer program product, or the memory, thus comprises instructions executable by the processor 40. Such instructions may be comprised in a computer program, or in one or more software modules or function modules.

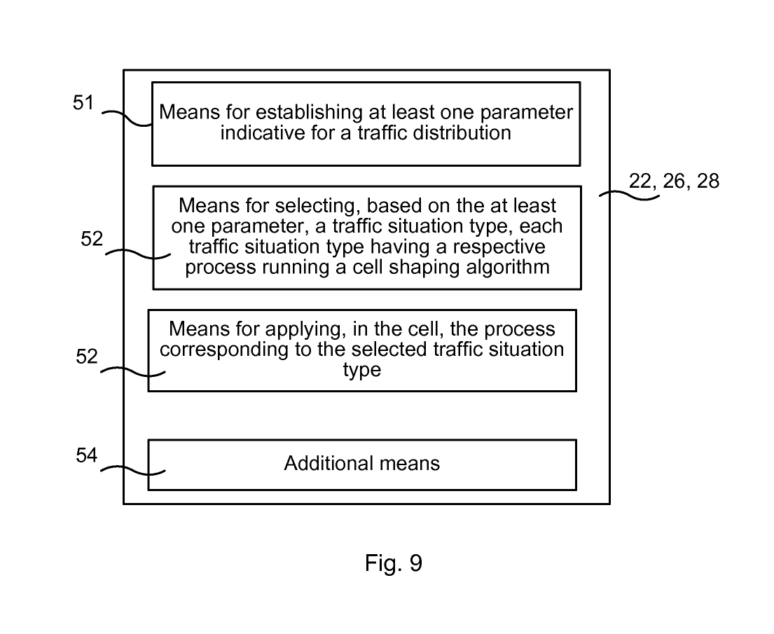

FIG. 9 illustrates a network node comprising means for implementing embodiments of the present teachings. The means, e.g. function modules, can be implemented using software instructions such as computer program executing in a processor and/or using hardware, such as application specific integrated circuits (ASICs), field programmable gate arrays, discrete logical components etc., and any combination thereof. Processing circuitry may be provided, which may be adaptable and in particular adapted to perform any of the steps of the methods that have been described.

A network node is provided for traffic dependent cell shaping. The network node comprises first means 51 for establishing at least one parameter indicative for a traffic distribution in a cell. The first means may comprise means for measuring a certain parameter, or means for retrieving, inquiring or receiving the parameter from a device, e.g. database or other network node.

The network node comprises second means 52 for selecting, based on the at least one parameter, a traffic situation type among at least a first and a second traffic situation types, wherein each traffic situation type has a respective process running a cell shaping algorithm. The second means 52 may for instance comprise processing circuitry adapted for such selection.

The network node comprises third means 53 for applying, in the cell, the process corresponding to the selected traffic situation type. The third means 53 may comprise processing circuitry adapted to output a signal to e.g. antenna control means, which in turn sets e.g. antennas according to the selected traffic situation type.

The means 51, 52, 53 can, as mentioned, be implemented using software instructions such as computer program executing in a processor and/or using hardware. Further, additional means, schematically indicated at reference numeral 54, may be provided for implementing the various embodiments of the present teachings. For instance, the network node may comprise additional means 54 for identifying traffic distribution in the cell as one of at least a first and a second traffic situation types or as a traffic situation type different than the at least first and second traffic situation types.

The invention has mainly been described herein with reference to a few embodiments. However, as is appreciated by a person skilled in the art, other embodiments than the particular ones disclosed herein are equally possible within the scope of the invention, as defined by the appended patent claims.

1. A method performed in a network node for traffic dependent cell shaping, the method comprising:
establishing at least one parameter indicative for a traffic distribution in a cell;
selecting, based on the at least one parameter, a traffic situation type among at least a first and a second traffic situation types, each traffic situation type having a respective process running a cell shaping algorithm and
applying, in the cell, the process corresponding to the selected traffic situation type.

2. The method as claimed in claim 1, further comprising identifying, based on the establishing, the traffic distribution in the cell at least one of:
as one of at least a first and a second traffic situation types; and
as a traffic situation type different than the at least first and second traffic situation types.

3. The method as claimed in claim 2, further comprising, for the case that the traffic distribution in the cell is identified as a traffic situation type different than the at least first and second traffic situation types, classifying the traffic distribution in the cell as a third traffic situation type.

4. The method as claimed in claim 1, further comprising grouping traffic distributions into one of the at least first and second traffic situation types based on the traffic distributions having one of:
at least one identical key performance indicator, KPI; and
differing less than a set value.

5. The method as claimed in claim 1, further comprising applying as initial values, in the respective process running the cell shaping algorithm, current process parameter values of the selected traffic situation type.

6. The method as claimed in claim 5, further comprising updating the process parameters of the process corresponding to the selected traffic situation type.

7. The method as claimed in claim 5, wherein the algorithm for improving the antenna settings comprises a re-configuration antenna system self-organizing network, RAS-SON, algorithm.

8. The method as claimed in any of the preceding claims claim 1, wherein the at least one parameter indicative for the traffic distribution comprises at least one taken from the group consisting of: utilization of a radio access node, utilization of a cluster of radio access nodes, offered traffic in the cell, positions of communication devices, total traffic load in a network, user bitrate and handover rate of communication devices.

9. The method as claimed in claim 1, wherein process parameters of the processes running the cell shaping algorithm comprise at least one taken from the group consisting of: antenna settings of a re-configurable antenna system, transmission power, number of sectors, number of communication device specific beamforming ports.

10. The method as claimed in claim 1, further comprising, for each process for which all process parameters have converged to their final values, applying these final values for the cell-shaping algorithm for the respective traffic situation type.

11. A computer storage medium storing a computer program for a network node for traffic dependent cell shaping, the computer program comprising computer program code, which, when executed on at least one processor on the network node causes the network node to perform the a method comprising:
establishing at least one parameter indicative for a traffic distribution in a cell;
selecting, based on the at least one parameter, a traffic situation type among at least a first and a second traffic situation types, each traffic situation type having a respective process running a cell shaping algorithm; and
applying, in the cell, the process corresponding to the selected traffic situation type.

12. (canceled)

13. A network node for traffic dependent cell shaping, the network node being configured to:
establish at least one parameter indicative for a traffic distribution in a cell;
select, based on the at least one parameter, a traffic situation type among at least a first and a second traffic situation types, wherein each traffic situation type has having a respective process running a cell shaping algorithm; and
apply, in the cell, the process corresponding to the selected traffic situation type.

14. The network node as claimed in claim 13, further configured to identify, based on the establishing, the traffic distribution in the cell at least one of:
as one of at least a first and a second traffic situation types; and
as a traffic situation type different than the at least first and second traffic situation types.

15. The network node as claimed in claim 13, further configured to, for the case that the traffic distribution in the cell is identified as a traffic situation type different than the at least first and second traffic situation types, classify the traffic distribution in the cell as a third traffic situation type.

16. The network node as claimed in claim 13, further configured to group traffic distributions into one of the at least first and second traffic situation types based on the traffic distributions having one of:
at least one identical key performance indicator, KPI; and
differing less than a set value.

17. The network node as claimed in claim 13, further configured to apply as initial values, in the respective process running the cell shaping algorithm, current process parameter values of the selected traffic situation type.

18. The network node as claimed in claim 17, configured to update the process parameters of the process corresponding to the selected traffic situation type.

19. The network node as claimed in claim 17, wherein the algorithm for improving the antenna settings comprises a re-configuration antenna system self-organizing network, RAS-SON, algorithm.

20. The network node as claimed claim 13, wherein the at least one parameter indicative for the traffic distribution comprises at least one taken from the group consisting of: utilization of a radio access node, utilization of a cluster of radio access nodes, offered traffic in the cell, positions of communication devices, total traffic load in a network, user bitrate and handover rate of communication devices.

21. The network node as claimed in claim 13, wherein process parameters of the processes running the cell shaping algorithm comprise at least one taken from the group consisting of: antenna settings of a re-configurable antenna system, transmission power, number of sectors, number of communication device specific beamforming ports.

22. The network node as claimed in claim 13, further configured to, for each process for which all process parameters have converged to their final values, apply these final values for the cell-shaping algorithm for the respective traffic situation type.
